(19) United States
(12) Patent Application Publication
(10) Pub. No.: US 2012/0110731 A1
(43) Pub. Date: May 10, 2012

(54) OVERHEAD PATIENT LIFT SYSTEM

(75) Inventor: Barry Hand, Mount Pleasant, SC (US)

(73) Assignee: BERCHTOLD HOLDING GMBH, Tuttlingen (DE)

(21) Appl. No.: 12/942,889

(22) Filed: Nov. 9, 2010

(51) Int. Cl. A61G 7/14

(52) U.S. Cl. 5/87.1; 5/83.1

(57) ABSTRACT

The present inventions relates to an overhead patient lift system which includes a boom and a lift connectable to a patient support and movable along said boom. The boom has a longitudinal direction and a first end connected and supported at a bearing, said boom intersects with a guide rail adapted to support said boom during movement about said bearing, wherein said guide rail does not interfere with said movement of said lift along said boom.

### BACKGROUND OF THE INVENTION

1. Field of the Invention

The present invention relates to an overhead patient lift system including a boom and a lift connectable to a patient support and moveable along the boom.

2. The Prior Art

Patient lift systems are typically mounted in or at ceilings of medical facilities. Prior art patient lifts include a ceiling lift motor in combination with a ceiling mounted boom arm. The boom is typically supported at a central bearing which may be mounted to a structure attached to the building, with the boom arm rotating about the central bearing up to 360°. Attached to or embedded to the underside of the boom arm is a linear track along which track the ceiling lift motor can move.

Standard lift systems offer limited maneuverability within the linear path provided by the track, since they have limited load capacities due to the restrictions on the central bearing and the structural integrity of the hospital building and boom arm design, i.e. when too high a load is provided at the ceiling lift motor this can cause the boom to cant relative to the central bearing and become inoperable as the boom can in some cases no longer be moved about the central bearing. To overcome this problem, the prior art teaches the use of expensive durable materials and/or to significantly increase the size of the boom and/or of the bearing. This is expensive in cost and frequently requires the provision of substantial support structures to carry the weight of the system complicating the installation of such systems immensely.

### BRIEF DESCRIPTION OF THE INVENTION

It is the object of the present application to provide an improved patent lift system in which the load bearing capabilities of prior art booms is increased and which enables the movement of heavier loads for larger distances using booms having the same weight or even less than those described in the prior art.

This object is satisfied in accordance with the independent claims. The dependent claims are directed at preferred embodiments of the apparatus in accordance with the invention.

An overhead patient lift system in accordance with the invention includes a boom and a lift connectable to a patient support and movable along said boom, wherein said boom has a longitudinal direction and a first end connected and supported at a bearing, said boom intersects with a guide rail adapted to support said boom during movement about said bearing, wherein said guide rail does not interfere with said movement of said lift along said boom.

Since the boom is now attached at two points in the system the loads carried by the lift attached to the boom can be increased and, more importantly, the lift can be maneuvered over substantially the complete length of the boom without the boom canting against the central bearing. This has the advantage that also heavy patients can be transported using the patient support and can be deployed at or picked up from virtually every point of the area covered beneath the boom.

The fact that the lower boom is now supported at two points also has the effect that the size and cost of the system and any required support structure can be significantly reduced.

Advantageously said lift is supported and moveable in a track mounted along said longitudinal direction on said boom which permits a horizontal movement of said patient support for loading and unloading a patient beneath said boom.

Using a track to guide the lift ensures a more secure and accurate passage of the load in the patient support along the boom. Moreover, the lift can be maneuvered easily beneath the total area covered by the length of the boom, permitting a larger area to be covered by the boom.

It is particularly beneficial when a cross section of said track and/or said guide rail substantially has/have a shape which is/are selected from the group of C-shaped, T-shaped, L-shaped and double T-shaped cross sections. In this way it can be ensured that, in particular whilst the lift is being moved along said track, the lift cannot become de-attached from the track, likewise a derailment of the boom from the guide rail can be avoided.

In a further embodiment of the present application there is provided an overhead patient lift system in which the boom is adapted to be moved by approximately 90° about said bearing. Moreover, the boom can preferably be moved by approximately 180° about said bearing and especially preferably by 360° about said bearing.

If the boom can move freely about the bearing e.g. by 360° about the bearing the area covered by the boom can be significantly increased with respect to a boom which cannot cover the full area beneath it.

In a further embodiment of the present application said guide rail is of substantially circular shape.

This circular track can be mounted surrounding the boom at a fixed distance from the central bearing with a constant radius, for example 36″ (approximately 0.91 m). A truck can run in the circular track (guide rail) which truck is attached to a connecting rod which is in turn attached to the upper surface of the boom arm. The circular track is sufficiently secured to support the end of the arm and the weight of the patient attached to the lift motor. The length of the boom can now be selected as required for installation in a medical facility and will generally be in the range from 0.5 m to approximately 10 m.

The unique innovation of adding the circular track to support the load at the distal end of the boom arm effectively eliminates the overhung moment load on the central bearing. This allows the arm to become as long as is practicable in the clinical setting. The limitation then becomes the design and material of the arm itself, which can be designed to provide support for the ceiling lift system at lower cost.

In a further embodiment of the present application said boom is a telescopic boom which can extend in said longitudinal direction.

Using a telescopic boom has the advantage that areas can be reached by the boom where a guide rail cannot be installed because the ceiling at that position is inaccessible due to obstacles, such as side walls or the like, which would block the passage of the boom. However the parts of the space lying behind this obstacle can now be reached with the boom still being beneficially supported at two points in the ceiling.

In a further embodiment of the present application said track is moveably mounted along said longitudinal direction of said telescopic boom.

This ensures that the lift can be moved freely along the total length of the telescopic boom ensuring that the patient support can be deployed at and/or picked up from any point of the area covered by the boom.

In a further embodiment of the present application said guide rail is of substantially curved shape, such as e.g. an elliptical shape.

Using a telescopic boom one can install an elliptical guide rail into a rectangular shaped hospital room or ward and still be able to reach as many of the desired positions as wanted and, more importantly, carry substantial loads to those positions.

In a further embodiment of the present application said shape of said guide rail has at least one mathematical turning point, for example said guide rail is an s-shaped guide rail.

In a further embodiment of the present application said guide rail has at least one transition gate to permit the transition of said lift from said boom to a further track.

Door transition gates can be positioned in such a way to allow the boom arm to align with them and provide easy transition of the patient support to e.g. an entire hospital track network.

In a further embodiment a battery charging dock location is advantageously provided in the overhead patient lift system. This is capable of charging the battery associated with the lift motor and/or the battery associated with the transition gate. This is particularly beneficial as one can now simply avoid running high voltage cables and/or tracks throughout a hospital track network. The fact that no high voltage cables are required has the beneficial side effects that the patient lift system can be classified in a different class of hospital appliances and that the patient lift system can also have a different safety rating which both reduce the cost of such system.

Advantageously said further track is arranged in a track system which permits the transfer of said lift from said boom to a loading station.

Advantageously the track system includes at least one further transition gate to permit the transfer of the lift from one boom to at least one further boom.

Including loading stations, further transition gates and further booms in a track system one can advantageously pick up a patient at one point in the network and transport him/her through the medical facility and unload the patient at a required position in the network either for treatment or for recovery following treatment.

In a further aspect of the present invention there is provided a track assembly which includes a lift connectable to a patient support and movable along at least one boom and at least one transition gate to permit the transition of said lift from said boom to a further track, wherein said boom has a longitudinal direction and a first end connected and supported at a bearing, said boom intersects with a guide rail adapted to support said boom during movement about said bearing, wherein said guide rail does not interfere with said movement along said boom.

The advantageous features are described in an exemplary manner only and are not intended to restrict the inventive apparatus in any way or form. The invention will be described in the following with regard to further features and advantages by way of examples with reference to embodiments in the enclosed drawings. The Figures of the drawings show:

### BRIEF DESCRIPTION OF THE DRAWINGS

FIG. 1A a schematic embodiment of the overhead patent lift system in accordance with the invention;

FIG. 1B a top view of the embodiment in accordance with FIG. 1B;

FIG. 2A a further schematic embodiment of the overhead patent lift system in accordance with the invention;

FIG. 2B a top view of the embodiment of FIG. 2A;

FIG. 2C a further top view of a guide rail using a boom as described in accordance with FIG. 2A;

FIG. 3A a further schematic embodiment in accordance with the invention;

FIG. 3B a top view of the embodiment of FIG. 3A;

FIG. 4A to D show sample cross-sections of the guide rails and tracks used in an overhead patient lift system in accordance with the invention;

FIG. 5A a schematic side view of transition gates used in an overhead lift system in accordance with the invention;

FIG. 5B a top view of the transition gates in accordance with FIG. 5A; and

FIG. 6 a schematic top view of a track network.

### DETAILED DESCRIPTION

Features having the same or similar function will be described in the following using the same reference numerals.

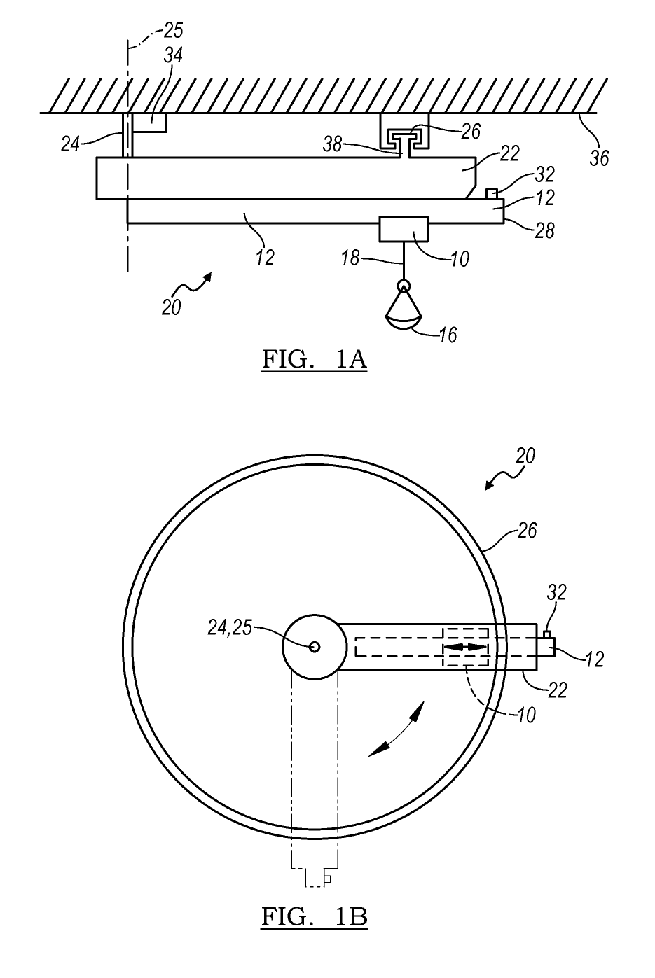

FIG. 1A shows a ceiling lift motor 10 and track 12. The lift motor 10 is horizontally movable in the U-shaped track 12 and can be driven by a drive 14 (not shown) to actuate a horizontal and/or vertical movement of the lift which can be connected to a patient support 16. The patient support 16 can be connected to a band 18 of the lift motor 10. To actuate the vertical movement of the band 18 the lift motor 10 either winds or unwinds the band 18 onto or from a reel (not shown) contained within the lift.

FIG. 1A shows a schematic side view of an overhead patient lift system 20. At its one end a boom 22 of the lift system 20 is connected and supported at a bearing 24 having a vertical pivot axis 25. At its second end along the longitudinal direction of the boom 22, the boom 22 is connected to a guide rail 26 which is adapted to support the boom 22 during movement about the bearing 24. The patient support 16 can be connected to the lift motor 10 and be moved both horizontally and vertically by the lift motor 10 to load and unload patients beneath the boom 22. Also indicated in FIG. 1A is a stopper 32 which forms an interface of the track 12 to a transition gate 30 (see FIG. 5A) which is explained in detail with reference to FIG. 5. The bearing 24 is positioned beside a battery charging dock station 34 which can be connected to a battery associated with the lift motor 10 (not shown) so that this can be used without high voltage cables and/or tracks having to be provided throughout a patient lift system 20 and/or even in the event of a power cut. The assembly 20 is mounted to the ceiling 36 but could also be installed in a floor mounted frame (not shown). The boom 22 is connected to the guide rail 26 using a truck 38.

FIG. 1B shows a top view of the overhead lift system 20 in accordance with FIG. 1A. In the present example of FIG. 1A the ceiling mounted guide rail 26 is a circular guide rail 26 and permits movement of the boom 22 through at least 360° about the bearing 24. Since the lift motor 22 is adapted to be moved horizontally in a track 12 along the bottom of the boom 22, the patient support 16 can be moved horizontally beneath the total area of the circle described by the boom 22 on movement thereof. As is clearly visible from FIG. 1B the guide rail 26 does not interfere with a movement of the lift motor 10 along the boom 22. In other words, the boom 22 can be moved about the pivot axis 25 using the guide rail 26 as a guide on the top surface of the boom 22 and the lift motor 10 attached to the bottom of the boom 22 can move along the longitudinal direction of the boom 22 to positions beyond the guide rail 26. The lift motor 10 is adapted to slide along the boom mounted track 12 and since the boom 22 is supported at the bearing 24 and by the circular sealing mounted guide rail 26 increased loads can be maneuvered beneath the area of the boom 22.

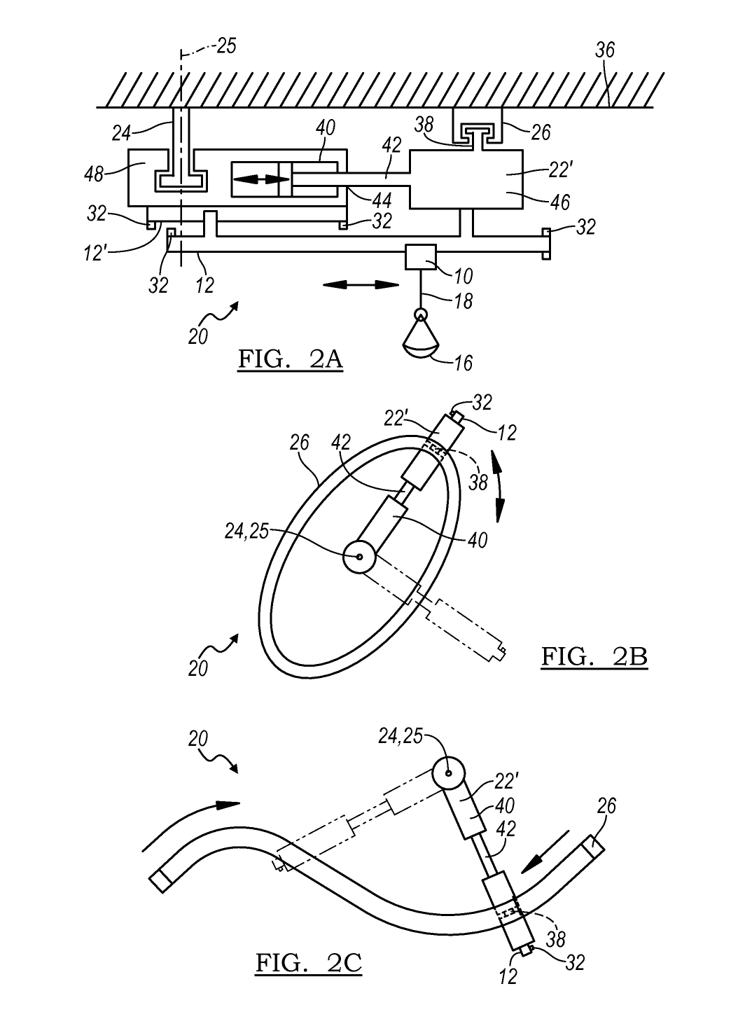

FIGS. 2A and 2B show a further embodiment of the overhead patient lift system 20 in accordance with the invention. In the embodiment of FIG. 2A one can see a schematic section through the telescopic boom 22′ which allows movement of the boom 22′ in a curved track or curved guide rail 26, i.e. not only a circular guide rail 26, but also an elliptical guide rail 26 or any arbitrarily shaped curved guide rail 26 can be used. This can also be an S-shaped track 26 which has a mathematically defined turning point. This can be utilized as is indicated in the example of FIG. 2B and FIG. 2C to maneuver patient supports 16 not only about 360° but also into confined spaces i.e. into corners of hospital rooms if the patient is to be unloaded in a rectangular room having a plurality of hospital beds.

The telescopic boom 22′ includes a guide member 40 which horizontally guides and supports a telescopic arm 42 through a guide slot 44 when the boom 22′ is extended. At its second end 46 the boom 22′ is connected to the track 12 along which the lift motor 10 can move. The track 12 is connected to a track assembly 12′ at the first end of the boom 22′.

FIG. 2B shows the movement of the boom 22′ in an elliptically shaped guide rail 26. On guiding the telescopic boom 22′ along the elliptically shaped guide rail 26 this extends and retracts and the track 12, 12′ associated with the boom 22′ can be moved along the length of the boom 22′ to load and unload the patient support 16 beneath it. FIG. 2C shows an example of an S-shaped guide track 26. The boom 22′ can be moved to and fro from one end of the S-shaped guide track 26 to the other.

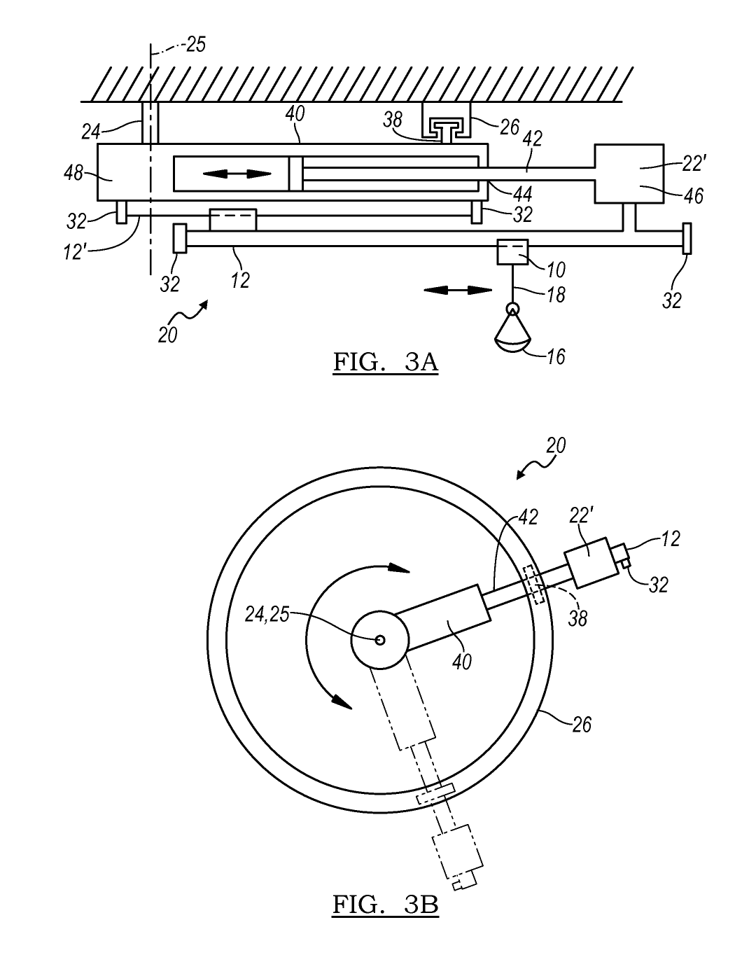

FIG. 3A shows a further embodiment of a telescopic boom 22′ in which the first end 48 of the boom 22′ is connected to the bearing 24 and the telescopic member 20 is connected to the curved guide rail 26 via a truck 38 and the second end 46 of the boom 22′ is connected via a telescopic apparatus 40, 42, 44 and can be extended to distances beyond the guide rail 26, this can be used in hospital wards where for reasons of ceiling 36 stability the boom cannot be directly connected to certain points of the ceiling, as air conditioning or lighting systems may be interfering at these points. Nevertheless, such a telescopic boom 22′ still allows the movement of the lift motor 10 beneath the complete area described by the boom 22′ if a suitable track system 12, 12′ is attached to the bottom of the telescopic boom 22′.

It is also conceivable that a substantially straight guide rail 26 (not shown) can be used in conjunction with a telescopic boom 22′. This then permits the movement of the patient support 16 to positions which would otherwise not be accessible, e.g. as a curved guide rail 26 cannot be installed due to other ceiling installations.

FIG. 3B shows a top view of the boom used in FIG. 3A. As can clearly be seen the patient support 16 can be extended beyond the guide rail 26 used in this example. It should be noted that independent of the type of boom 22, 22′ used, the patient support 16 can be moved to positions along the track 12 which extend beyond the guide rail 26.

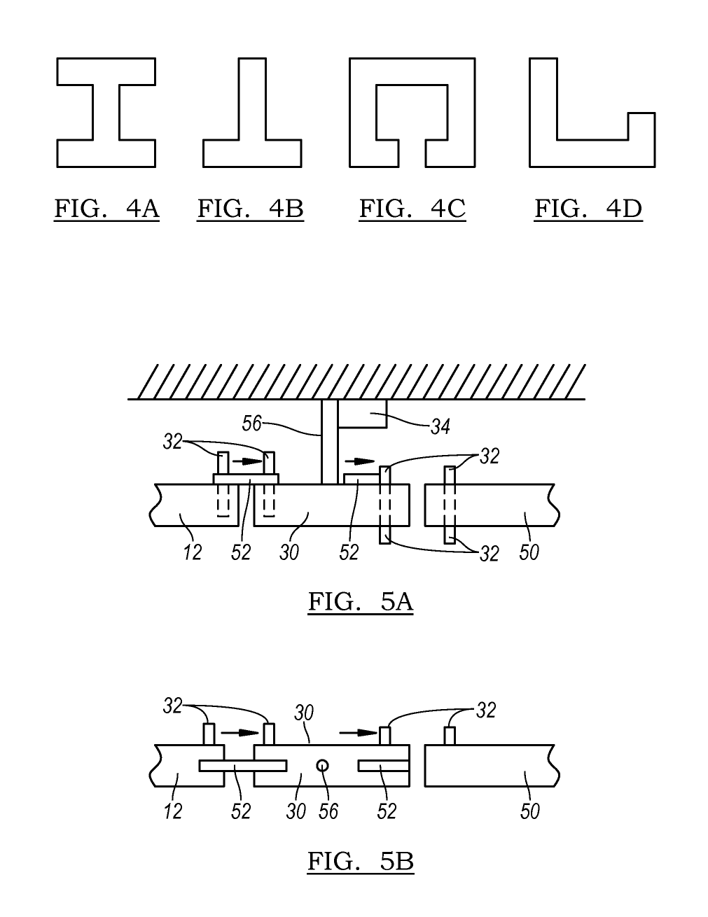

Turning now to FIGS. 5A to D, these show examples of different types of guide rails 26 and/or track 12, 12′ cross-sections. In principle any shape of track 12, 12′ or guide rail 26 cross-section can be used. FIG. 4A shows a double T-shaped cross-section which is also known as an H-shaped cross-section which can be used for a guide rail 26 and/or track 12, 12′. FIG. 4B shows a T-shaped cross-section of a guide rail 26 and/or track 12, 12′. FIG. 4C shows a U-shaped cross-section for a guide rail 26 and/or track 12, 12′. Finally, FIG. 4D shows an L-shaped cross-section for a guide rail 26 and/or track 12, 12′.

Turning now to FIG. 5A, a side view of two transition gates 30 is shown. These only permit movement of the lift motor 10 from the track 12 attached to the boom 22, 22′ to a further track 50, when one of these two are aligned and locked together with a transition gate 30, using e.g. a magnetic lock 52 or a mechanic lock 52. If the transition gate 30 is not aligned 100% with either the track 12 connected to the boom 22, 22′ or the further track 50 the transition gate 30 prevents the movement of the lift motor 10. Thereby ensuring that the lift motor 10 and/or a patient transported in the patient support 16 cannot be transported beyond the end of the track 12, 50 when the transition gate 30 is not aligned with the track 12 or the further track 50. Generally speaking any type of transition gate 30 can be used in the overhead patient lift system 20 in accordance with the present application, provided it is capable of transporting the lift motor 10 and ensures that the lift motor 10 cannot leave the track 12 and/or further track 50 when the transition gate 30 is not aligned with this.

In the example of FIG. 5A one can see that the left transition gate 30 is aligned and the stoppers 32 preventing the transition of the lift motor 10 across the gate 30 are in there retracted position, as a locking member 52 has moved across the gate 30 and locked the track 12 to the transition gate 30. Once this locking member 52 has locked the transition gate 30 either a magnetic or mechanical lock 52 mechanism can be actuated as is known from the prior art to move the stoppers 32 into their retracted position. The transition gate 30 is connected to the ceiling 30 using a suitable support 56.

The right transition gate 30 is in its open position, i.e. the locking member 52 is in its retracted position and the stoppers 32 are in their deployed state such that the lift motor 10 cannot cross the transition gate 30 there.

FIG. 5B shows a side view of a transition gate 30 when this is aligned with the track 12 attached to the boom 22, 22′ but not with the further track 50.

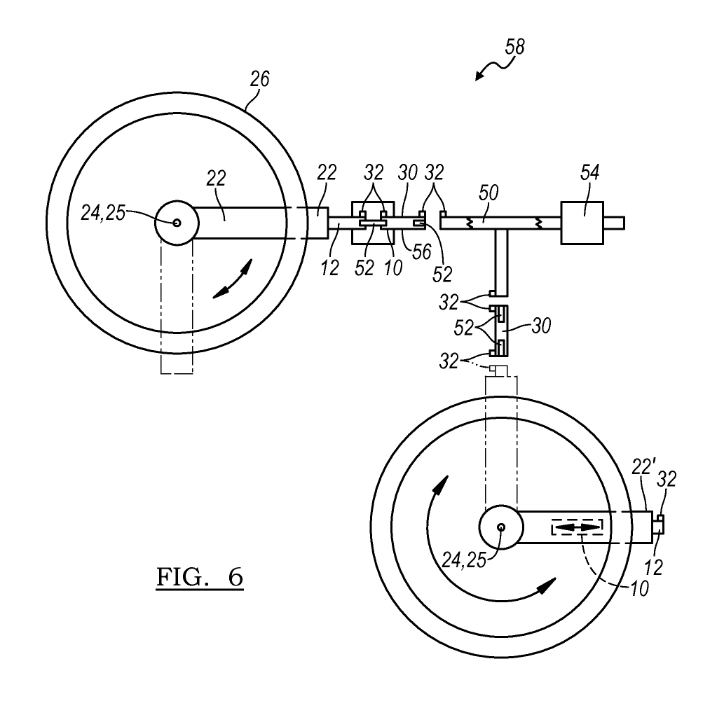

FIG. 6 shows an assembly having a boom 22 which is supported and connected at a first end 48 to a bearing 24 and intersects a guide rail 26 which supports the boom 22 without interfering with the movement of the lift motor 10 along the track 12 of the boom 22. Also shown are two transition gates 30, which are connected to further tracks 50 which end either at a further boom 22′ and at to a loading station 54 where patients can simply be hoisted into the patient support 16 for the transfer to either an operating theatre, a hospital ward or any other desired position within the track system 58.

Materials for the guide rails 26 and/or track 12 can be any metal material such as aluminum, or stainless steel or generally any type of material suitable for transporting the loads described herein. Typically patients are transported in the track system 58 of such overhead patient lift systems 20 if they are incapacitated due to health reasons or, because of an anesthetic which have not yet worn off so that they are momentarily incapacitated from moving e.g. from an operating table to a hospital bed in a post-operation wake-up room or even to the hospital bed in the ward they are assigned to.

We claim:

1. An overhead patient lift system including a boom and a lift connectable to a patient support and movable along said boom, wherein said boom has a longitudinal direction and a first end connected and supported at a bearing, said boom intersects with a guide rail adapted to support said boom during movement about said bearing, wherein said guide rail does not interfere with said movement of said lift along said boom.

2. An overhead patient lift system in accordance with claim 1, wherein said lift is supported in a track mounted along said longitudinal direction on said boom to permit a horizontal movement of said patient support for loading and unloading a patient beneath said boom.

3. An overhead patient lift system in accordance with claim 2, wherein a cross section of said track substantially has a shape which is selected from the group of C-shaped, T-shaped, L-shaped and double T-shaped cross sections.

4. An overhead patient lift system in accordance with claim 1, wherein said guide rail permits movement by approximately 90° about said bearing and preferably by approximately 180° about said bearing and especially by 360° about said bearing.

5. An overhead patient lift system in accordance with claim 1, wherein a cross section of said guide rail substantially has a shape which is selected from the group of C-shaped, T-shaped, L-shaped and double T-shaped cross sections.

6. An overhead patient lift system in accordance with claim 1, wherein said guide rail is of substantially circular shape.

7. An overhead patient lift system in accordance with claim 1, wherein said boom is a telescopic boom which can extend in said longitudinal direction.

8. An overhead patient lift system in accordance with claim 7, wherein said track is moveably mounted along said longitudinal direction of said telescopic boom.

9. An overhead patient lift system in accordance with claim 6, wherein said guide rail is of substantially curved shape.

10. An overhead patient lift system in accordance with claim 6, wherein said shape of said guide rail has at least one mathematical turning point, for example said guide rail is an s-shaped guide rail.

11. An overhead patient lift system in accordance with claim 1, wherein said guide rail has at least one transition gate to permit the transition of said lift from said boom to a further track.

12. An overhead patient lift system in accordance with claim 1, wherein a battery docking station is provided in the lift system which is adapted to recharge a battery associated with said lift.

13. An overhead patient lift system in accordance with claim 11, wherein a battery docking station is provided in the lift system which is adapted to recharge a battery associated with said transition gate.

14. An overhead patient lift system in accordance with claim 11, wherein said further track is arranged in a track system which permits the transfer of said lift from said boom to a loading station.

15. An overhead patient lift system in accordance with claim 11, wherein said track system includes at least one further transition gate to permit the transfer of the lift from one boom to at least one further boom.

16. A track assembly including a lift connectable to a patient support and movable along at least one boom and at least one transition gate to permit the transition of said lift from said boom to a further track, wherein said boom has a longitudinal direction and a first end connected and supported at a bearing, said boom intersects with a guide rail adapted to support said boom during movement about said bearing, wherein said guide rail does not interfere with said movement along said boom.
